(19) United States
(12) Patent Application Publication
(10) Pub. No.: US 2005/0211397 A1
(43) Pub. Date: Sep. 29, 2005

(54) Device with improved shutter

(76) Inventor: Benoit Coenraets, Brussels (BE)

Correspondence Address: BROWDY AND NEIMARK, P.L.L.C.;624 NINTH STREET, NW, SUITE 300, WASHINGTON, DC, 20001-5303, US

(21) Appl. No.: 10/508,197

(22) PCT Filed: Jan. 28, 2003
(86) PCT No.: PCT/BE03/00010

§ 371 Date: May 17, 2005

(30) Foreign Application Priority Data
Mar. 20, 2002 (BE) 2002/0198

(51) Int. Cl. E06B 9/17

(52) U.S. Cl. 160/271

(57) ABSTRACT

The invention relates to a shutter device designed to close off a bay (6) or other opening, the shutter (1) having side edges (2, 3) displaced in guide tracks (4, 5), in which lubricating means (38, 39, 48, 49, 52) are provided, enabling the side edges (2, 3) of the shutter (1) to be lubricated.

The invention relates to a shutter device designed to close off a bay or other opening, the shutter having at least one side edge displaced in a guide track and which can be moved between an open position and a closed position.

Existing devices of this type have major disadvantages. In particular, it is necessary to apply a relatively high amount of force in order to displace the shutter between its closed position and its open position. Furthermore, the shutter is displaced at a relatively slow speed to ensure that it is not subjected to damage as it is moved into the open or closed position. As the shutter is being moved to its closed position by applying a thrust force on the side edges of the shutter, these edges may well pucker and jam in the guide tracks, thereby preventing the shutter from being moved.

The purpose of the invention is to overcome these drawbacks by proposing a device that will enable the shutter to be displaced between its open position and its closed position at a higher speed without being damaged, whilst ensuring that its side edges do not jam in the guide tracks.

To this end, the invention proposes lubricating means, which will enable the coefficient of friction at the side edges of the shutter in the guide tracks to be reduced.

In one advantageous embodiment of the invention, the lubricating means comprise a lubricating element facing the side edge of the shutter, which enables this shutter to be lubricated relative to the corresponding guide track.

In one specific embodiment of the invention, the lubricating element co-operates with a reservoir containing liquid lubricant.

The lubricating element advantageously comprises a wick, one of the ends of which extends into said reservoir.

In one practical embodiment of the device proposed by the invention, said wick has a cutout at one of its ends, in which the side edge of the shutter is accommodated.

The reservoir advantageously extends along at least a part of the guide track.

In another embodiment of the device proposed by the invention, the lubricating element comprises a rotating member bearing against the side edge of the shutter so that this member rotates as the shutter is opened or closed, it being possible for this member to co-operate with said reservoir in order to distribute the liquid lubricant on the side edge of the shutter as the member rotates.

In an alternative embodiment of the shutter device proposed by the invention, the shutter is wound about a drum as the shutter is opened, this drum being at least partially hollow and containing said reservoir.

Other details and features of the invention will become clear from the description below, which is not intended to be restrictive, of various specific embodiments of a shutter device as proposed by the invention, given with reference to the appended drawings.

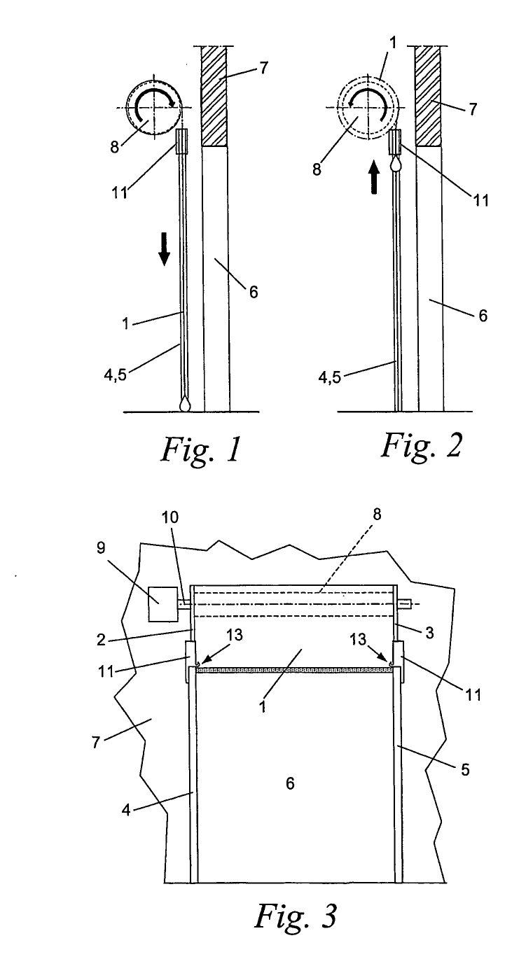

FIG. 1 is a schematic diagram in vertical section showing a first embodiment of a shutter device as proposed by the invention with the shutter in the closed position.

FIG. 2 is a view similar to that shown in FIG. 1, with the shutter in its open position.

FIG. 3 is a front view of the shutter device in the open position.

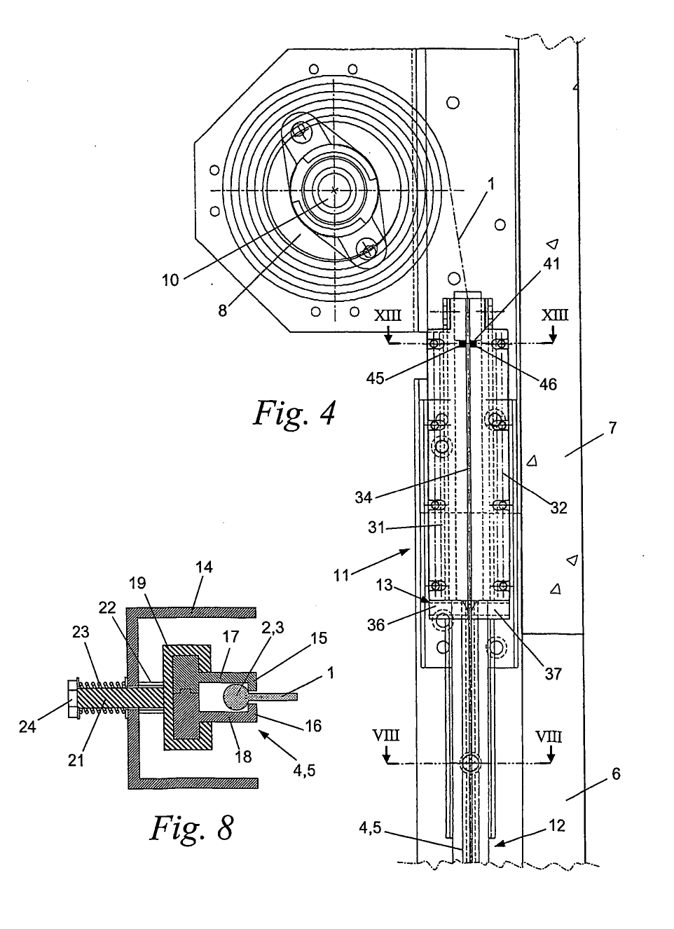

FIG. 4 is a schematic illustration of the top part of the guide tracks of the shutter device proposed by the invention.

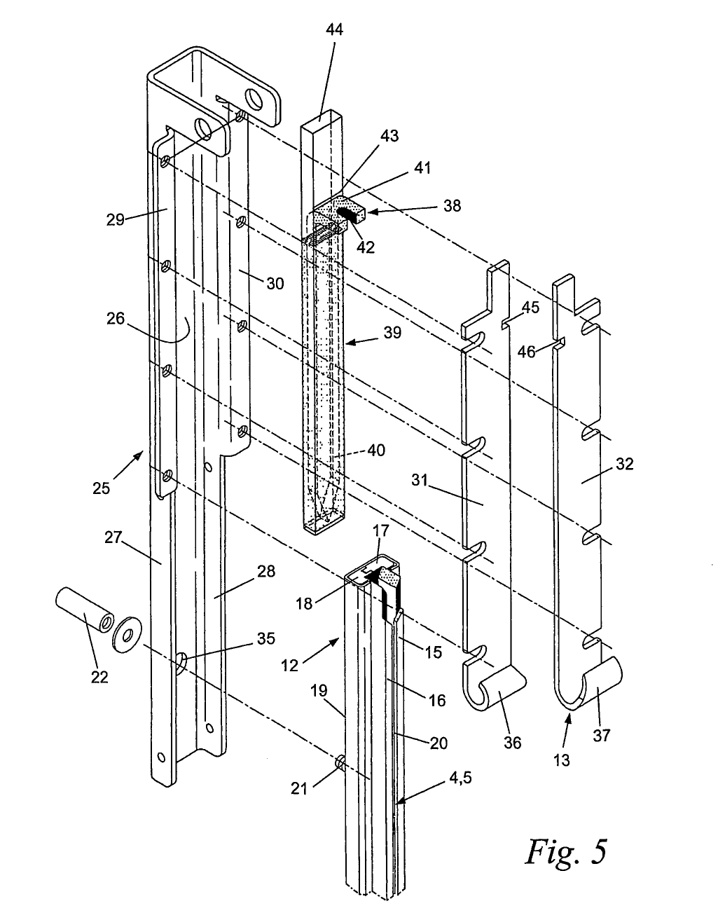

FIG. 5 is an exploded view of the top part of the guide tracks of the shutter device proposed by the invention.

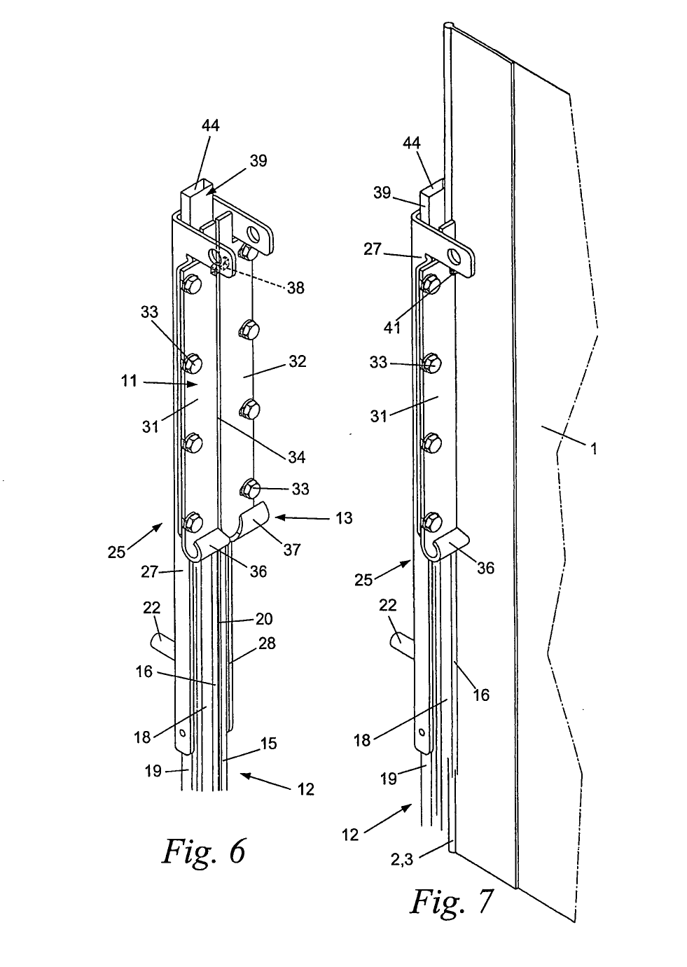

FIG. 6 is a schematic diagram in perspective, showing the top part of the guide tracks of the shutter device proposed by the invention.

FIG. 7 is a schematic diagram of the top part of the guide tracks of the shutter device proposed by the invention when the shutter is in the closed position.

FIG. 8 is a section along line VIII-VIII indicated in FIG. 4.

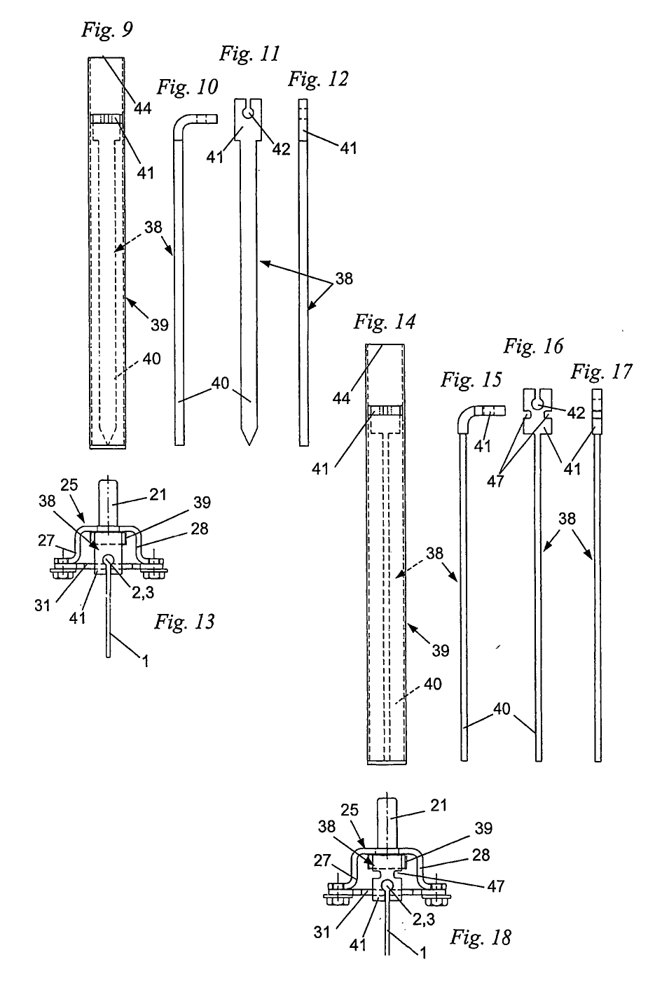

FIG. 9 is a front view of a reservoir in which a wick is housed, in one specific embodiment of the invention.

FIG. 10 is a side view of the wick illustrated in FIG. 9.

FIG. 11 is a front view of the wick illustrated in FIGS. 9 and 10 in a planar position.

FIG. 12 is a side view of the wick illustrated in FIG. 11.

FIG. 13 is a section along line XIII-XIII indicated in FIG. 4, in which the shutter device is fitted with the wick illustrated in FIGS. 10 to 12.

FIG. 14 is a front view of a reservoir in which a wick is housed, in one specific embodiment of the invention.

FIG. 15 is a side view of the wick illustrated in FIG. 14.

FIG. 16 is a front view of the wick illustrated in FIGS. 14 and 15 in a planar position.

FIG. 17 is a side view of the wick illustrated in FIG. 16.

FIG. 18 is a section along line XIII-XIII indicated in FIG. 4 where the shutter device is fitted with the wick illustrated in FIGS. 15 to 17.

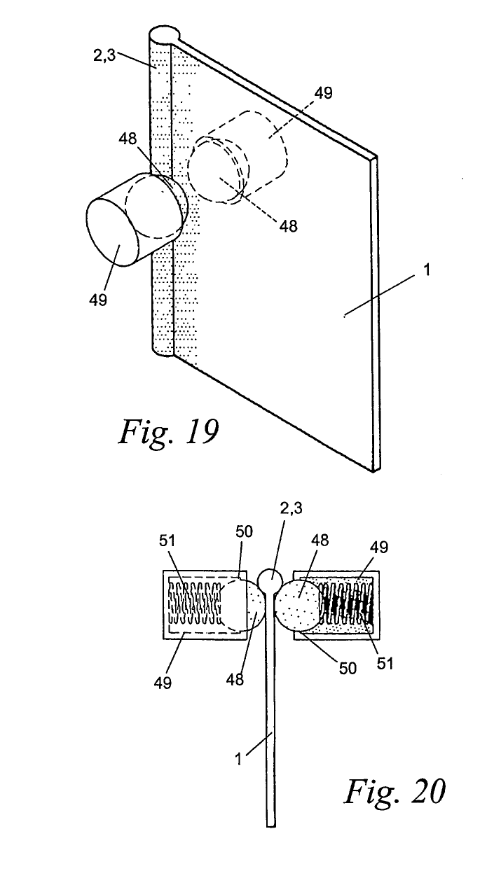

FIG. 19 is a schematic view in perspective of a shutter with two rotating members as proposed by the invention.

FIG. 20 is a cross-section through FIG. 19.

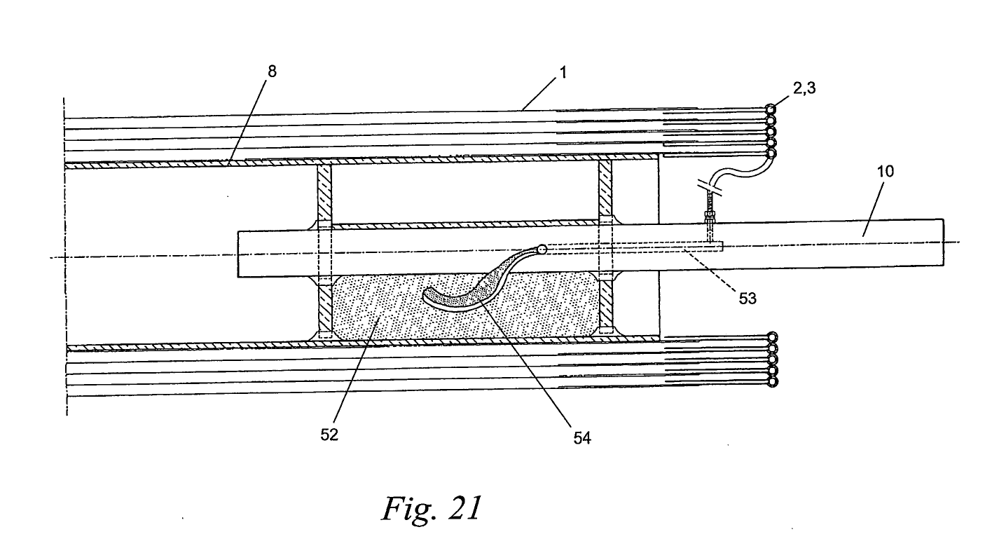

FIG. 21 is a horizontal section through a drum provided with a reservoir for a liquid lubricant, as proposed in one practical embodiment of the invention.

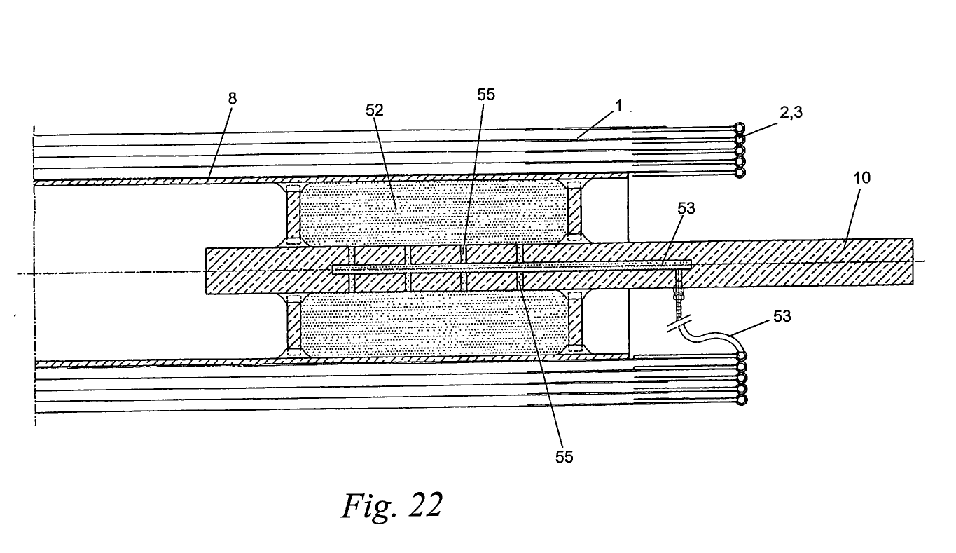

FIG. 22 shows a horizontal section of a drum provided with a reservoir for a liquid lubricant, as proposed in an alternative embodiment of the invention.

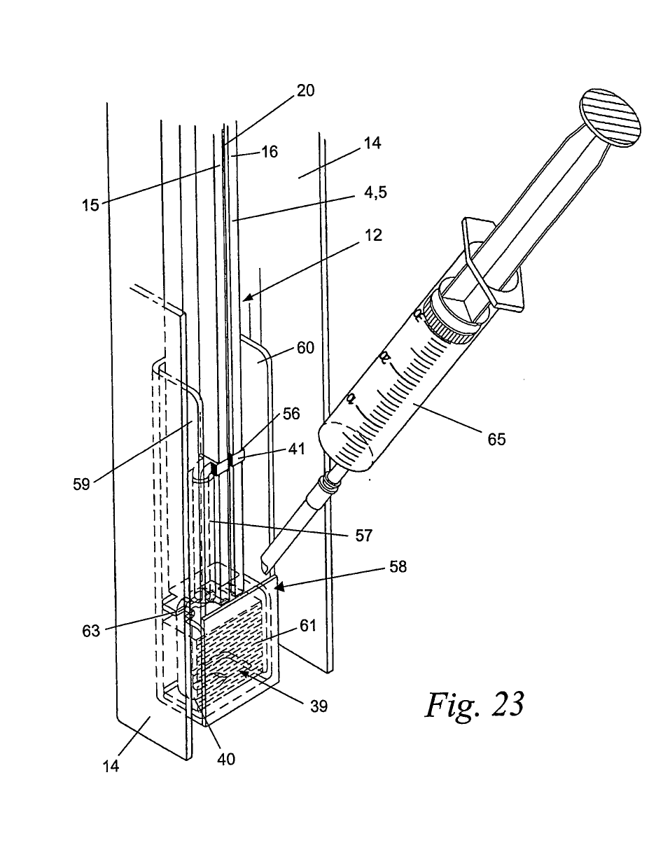

FIG. 23 is a schematic diagram, in perspective, of one very practical embodiment of a lubricating system proposed by the invention.

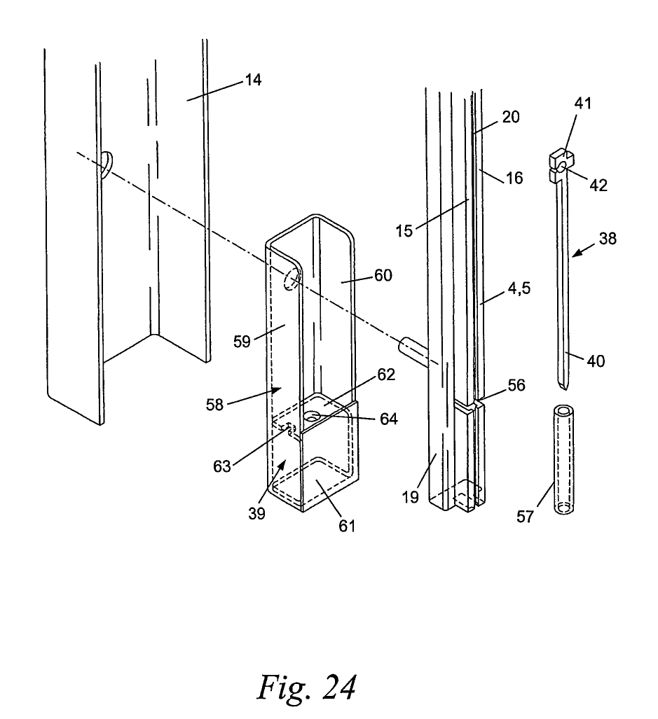

FIG. 24 is a schematic exploded view of the lubricating system illustrated in FIG. 23.

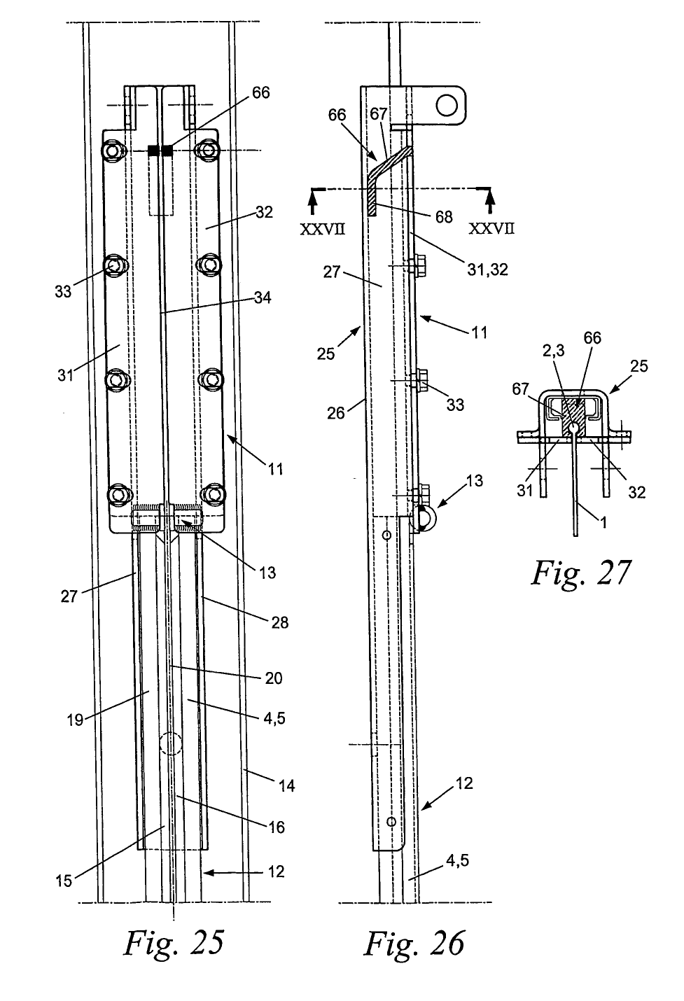

FIG. 25 is a font view of the top part of the guide tracks of the shutter device proposed by the invention.

FIG. 26 is a side view of the top part of the guide tracks illustrated in FIG. 25.

FIG. 27 is a section along line XXVII-XXVII indicated in FIG. 26.

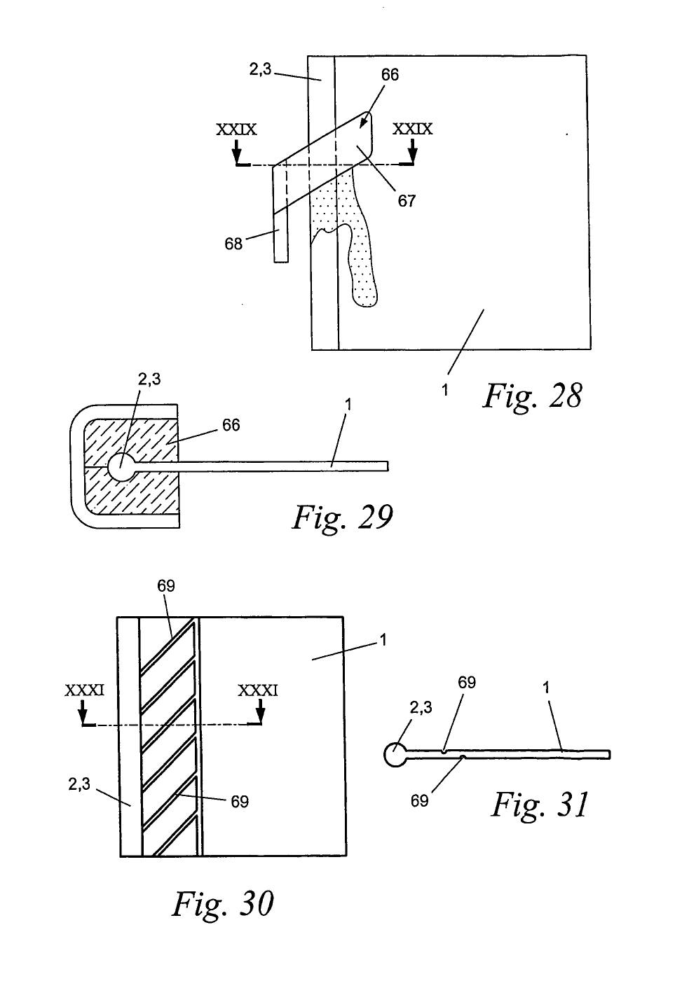

FIG. 28 is a very schematic diagram of a scraper element with a part of a shutter.

FIG. 29 is a section along line XXIX-XXIX indicated in FIG. 28.

FIG. 30 is a front view of part of a side edge of a shutter proposed by the invention.

FIG. 31 is a section along line XXXI-XXXI of FIG. 30.

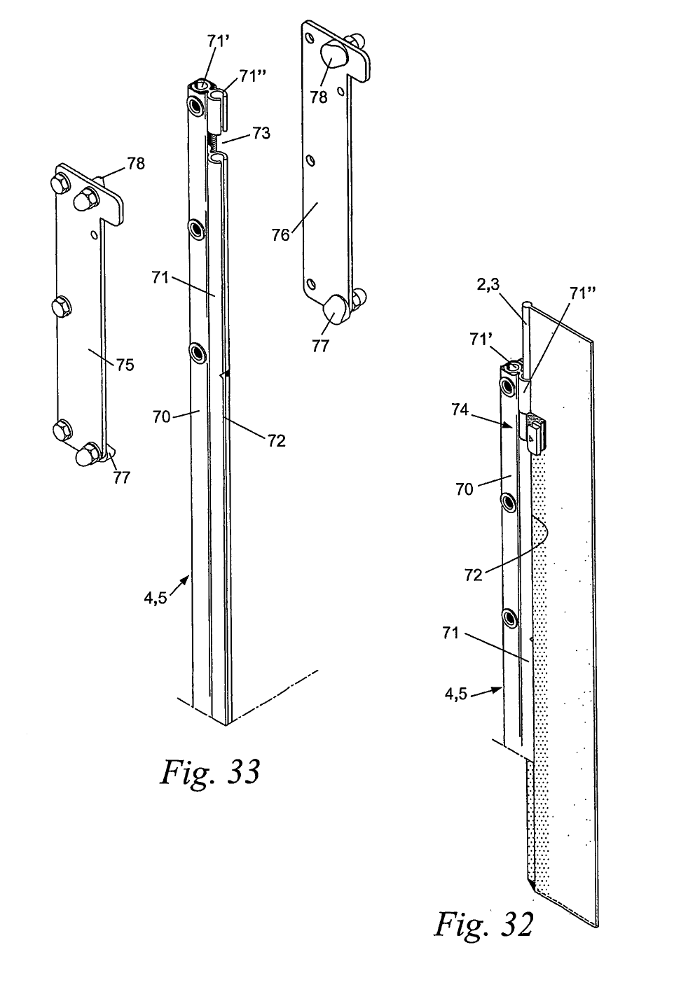

FIG. 32 is a schematic view in perspective of a part of a guide track with the lubricating element, in one specific embodiment of the invention.

FIG. 33 is a schematic exploded view of a guide track with re-locating means.

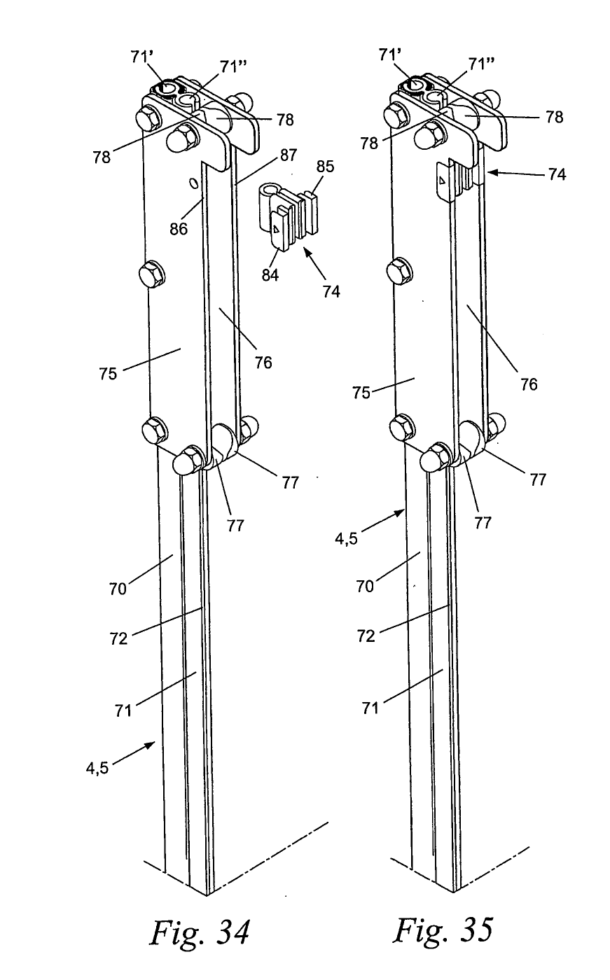

FIG. 34 is a schematic view in perspective of the guide track with the re-locating means.

FIG. 35 is a view similar to that shown in FIG. 34 when the lubricating element is mounted to the re-locating means.

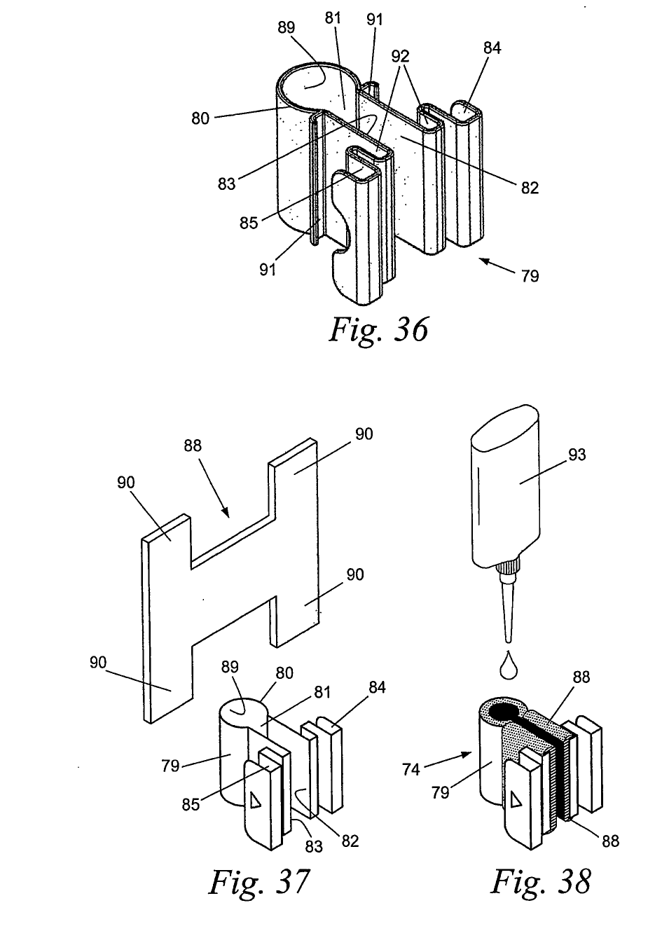

FIG. 36 is a schematic view in perspective of a part of the lubricating element.

FIG. 37 is a view in perspective of a part of the lubricating element and of the covering for this element.

FIG. 38 is a view in perspective of the lubricating element in FIG. 37 with a covering impregnated with a liquid lubricant. The same reference numbers are used in the different drawings to denote identical or similar elements.

Generally speaking, the present invention relates to a shutter device co-operating with driving means, such as a drum, the axis of which is connected to the shaft of an electric motor. The shutter, the side edges of which are lubricated as they are displaced in the guide tracks, is displaced in a downward and upward motion between a closed position and an open position respectively, and is designed to close off a bay in a wall or a passage, such as a corridor.

The word “shutter” as used in the context of the present invention should be construed as meaning any planar element which is at least partially pliable, flexible, semi-rigid, rigid or having one or more stiffeners, such as a canvas, a strip of plastics material, a metal cover, a trellis, a metal sheet or a metal shutter, etc. . . . Accordingly, the shutter may be provided in the form of a sectional door.

It should be pointed out, however, that particular preference is given to flexible shutters in the form of a canvas, for example. The appended drawings relate more specifically to such a canvas.

FIG. 1 provides a schematic illustration of the shutter device in the closed position, whilst FIGS. 2 and 3 show the shutter device in the open position. This device comprises a shutter 1 with side edges 2 and 3 projecting beyond the plane of the shutter, which are advantageously provided in the form of a continuous bead or a succession of small blocks articulated one about the other displaced in guide tracks 4 and 5. The guide tracks 4 and 5 are provided at either side of a bay 6 arranged in a wall 7.

Provided above the bay 6 is a drum 8, on which the shutter 1 can be wound. Driving means 9, such as an electric motor for example, activate a shaft 10 extending along the axis of the drum 8 to enable the shutter 1 to be wound on the drum 8 to bring it into the open position or enabling it to be unwound into its closed position.

The guide tracks 4 and 5 consist of a top part 11 and a bottom part 12, as illustrated in FIGS. 4, 5, 6 and 7. The top part 11 is provided with re-locating means 13. These re-locating means 13 enable the side edges 2 and 3 to be re-located in the guide tracks 4 and 5 during opening of the shutter 1 when they are released from the guide tracks 4 and 5. The side edges 2 and 3 may be released if there is an obstacle between the guide tracks 4 and 5 when the shutter 1 is being closed, for example, or if a vehicle has collided with the shutter 1, for example.

FIG. 8 illustrates a section through the bottom part 12 of the guide tracks 4 and 5. A support 14 having a U-shaped section encloses the guide tracks 4 and 5, which are provided with two longitudinal rims 15 and 16 extending on either side of the side edges 2 and 3 of the shutter 1. These rims 15 and 16 are directed towards one another forming a slit 20 so as to partially enclose the side edges 5 or 6 of the shutter 1. In the embodiment illustrated in FIG. 8, each guide track 4 and 5 comprises two separate sections 17 and 18, which are retained in a substantially C-shaped base section. Threaded rods 21 are welded by one on of their ends at regular distances along the back of the section 19.

The bottom part 12 of the guide tracks 4 and 5 is elastically and/or pivotably mounted relative to the fixed support 14. The threaded rods 21 extend through the support 14 and a rigid sleeve 22 is threaded onto the rod 21 between section 19 and section 14. A helical spring 23 is also provided between the latter and a nut 24 screwed onto the end of the threaded rods 21. This mounting of the guide tracks 4 and 5 is described and illustrated in patent specification EP 0 587 586, for example.

The top part 11 of the guide tracks 4 and 5 has a frame 25 with a U-shaped section having a base 26 and two flanges 27 and 28. The flanges 27 and 28 are folded towards the exterior to form two rims 29 and 30 extending substantially parallel with the base 26. A flat piece 31 and 32 is secured to each of these rims 29 and 30 by means of bolts 33. Each of the flat pieces 31 and 32 is provided with a substantially continuous edge directed one towards the other so that a slit 34 is formed between these flat pieces 31 and 32.

The projecting side edge 2 or 3 of the shutter 1 is accommodated in the space formed between the flanges 27 and 28 of the frame 25, so that the shutter 1 extends through the slit 34. The width of this slit 34 is slightly larger than the thickness of the shutter 1 and smaller than the thickness of the projecting edge 2 and 3 so that this edge can not come out through the space between the flanges 27 and 28 whilst allowing the actual shutter to slide between the edges facing the flat pieces 31 and 32.

The top end of the bottom part 12 of the guide tracks 4 and 5 is fixed to the frame 25 between the flanges 27 and 28 so that the slit 34 between the flat pieces 31 and 32 is aligned with the slit 20 between the rims 15 and 16. To this end, a threaded rod 21 extends through a cutout 35 provided in the base 26 of the frame 25. A rigid sleeve 22 is threaded onto the rod 21 between the frame 25 and the support 14. In order to preserve clarity in the drawings, the latter is not illustrated in FIGS. 5 to 7.

The end of the flat pieces 31 and 32 facing the bottom part 12 of the guide tracks 4 and 5 is folded back in the shape of a loop, thereby forming a rounded surface 36 and 37. As the shutter 1 is opened, once the side edges 2 and 3 of the shutter 1 have been released from the bottom part 12 of the guide tracks, these rounded surfaces 36 and 37 exert a thrust force on the side edges 2 and 3 of the shutter 1 so as to re-locate the latter in the top part 11 of the guide tracks between the flanges 27 and 28 of the frame 25.

In the embodiment of the shutter device illustrated in FIGS. 5 to 7, the part of the rims 15 and 16 facing the rounded surfaces 36 and 37 is cut away to make it easier to re-locate the side edges 2 and 3 in the guide tracks 4 and 5.

The end of the bottom part 12 of the guide tracks facing the rounded surfaces 36 and 37 is bevelled to ensure that the shutter 1 move continuously as it is displaced into its closed position.

The shutter device proposed by the invention is provided with a lubricating element to improve the sliding action of the side edges 2 and 3 of the shutter 1 in the guide tracks 4 and 5. In particular, this lubricating element is a wick 38 which can be inhibited by a liquid lubricant, such as oil, and is in permanent contact with the side edges 2 and 3 of the shutter 1.

In the shutter device illustrated in FIGS. 5 to 7, this wick 38 is provided in the form of a strip of porous material capable of absorbing a liquid lubricant, for example a strip of fabric, and is provided in the region of the top part 11 of the guide tracks 4 and 5. The wick 38 extends into a reservoir 39 containing said liquid lubricant. At least the bottom end 40 of the wick 38 is immersed in this liquid lubricant. The other end 41 is in contact with the side edges 2 and 3 of the shutter 1 so that the liquid lubricant from the reservoir 39 is distributed on these side edges 2 and 3.

As illustrated in FIG. 5, the top end 41 of the wick 38 is folded in a right angle and has a recess 42 in which the side edge 2 or 3 of the shutter 1 is accommodated. This enables the liquid lubricant to be distributed substantially uniformly along the contour of the side edges 2 and 3 of the shutter 1. In particular, this end 41 of the wick 38 extends beyond the side edges 2 and 3 of the shutter 1 so that the region of the shutter 1 extending through the slits 20 and 34 of the guide tracks 4 and 5, close to the side edges 2 and 3, is also lubricated. For this reason, the flat pieces 31 and 32 have a cutout 45 and 46, through which the end of the wick 38 extends, lubricating the region of the shutter 1 close to its side edges.

The reservoir 39, which is tubular in shape, extends along the guide tracks 4 and 5. This reservoir is located between the flanges 27 and 28 of the frame 25 and in particular is housed between the base 26 of the frame 25 and the side edges 2 and 3 of the shutter 1.

The top part of the reservoir 39 is provided with a rectangular cutout 43 through which the top end 41 of the wick 38 extends. Consequently, the bottom end 40 of the wick 38 extends substantially in the direction of the guide tracks 4 and 5 whilst the top end 41, which is in contact with the side edges 2 and 3 of the shutter 1, extends substantially transversely to this direction.

The reservoir 39 has an orifice 44 at its top part, through which liquid lubricant can be introduced.

Not only does the wick 38 lubricate the side edges 2 and 3 of the shutter 1 as it is displaced into its closed position or into its open position, it also enables these side edges 2 and 3 to be constantly cleaned.

FIGS. 9 to 13 illustrate another embodiment of the wick 38. The top end 41 of the wick 38 has a cutout 42, the dimensions and shape of which match the contours of the side edges 2 and 3 of the shutter 1 and the region of the shutter 1 in the vicinity of these edges 2 and 3. In particular, this cutout 42 is shaped in a circle which joins up with a slit enclosing the region of the shutter 1 close to its side edges 2 and 3.

FIGS. 14 to 18 illustrate yet another embodiment of the wick 38, which differs from the embodiment described above due to the presence of a notch 47 located at the top end 41 of the wick 38. In particular, this notch 47 located between the cutout 42 designed to enclose the side edges 2 and 3 of the shutter 1 and the bottom end 40 housed in the reservoir 39. Accordingly, the flow rate of the liquid lubricant from the reservoir 39 to the side edges 2 and 3 of the shutter 1 can be controlled.

FIGS. 19 and 20 illustrate yet another embodiment of the lubricating element proposed by the invention. This lubricating element has a spherically shaped rotating member 48, which is mounted so as to bear against the side edge 2 or 3 of the shutter 1. As illustrated in these drawings, such a rotating member 48 is provided on either side of the plane of the shutter 1. The rotating member 48 is more specifically in contact with the side edge of the shutter 1 at the same point at which this side edges slides against the rims 15 and 16 of the guide tracks 4 and 5. To enable this rotating member 48 to be mounted, a cutout is preferably provided in the guide tracks 4 and 5. Alternatively, the rotating member 48 is mounted facing the top end of the guide tracks 4 and 5.

This rotating member 48 co-operates with a reservoir 49 containing a liquid lubricant. In particular, the rotating member 48 is housed in the reservoir 49, which is cylindrical in shape, and extends partially through a circular orifice 50 provided in this reservoir 49. The rotating member 48 is a bearing, which is held against the edge of the orifice 50 by means of a helical spring 51. The diameter of the orifice is 50 smaller than the diameter of the bearing so that the latter is unable to slip out of the reservoir 49.

When the shutter 1 is displaced between its open position and its closed position, this rotating member 48 is caused to rotate due to the friction between the rotating member and the corresponding edge of the shutter 1. During this rotation, the liquid lubricant in the reservoir is transferred to the side edges of the shutter 1 via the surface of the rotating member 48.

Accordingly, whenever the shutter is moved in the direction of the guide tracks 4 and 5, liquid lubricant is distributed on the side edges 2 and 3 of the shutter 1 and on the region of the shutter 1 close to the side edges 2 and 3.

This embodiment of the lubricating element is particularly practical because it enables the liquid lubricant to be metered quite precisely on the edges of the shutter 1. In effect, once a sufficient quantity of liquid lubricant has been applied to the edges of the shutter, the friction between the rotating member and the corresponding side edge of the shutter becomes negligible, so that the rotating member 48 is no longer driven by the displacement of the shutter 1 but slides on it and, as a result, no additional liquid is distributed on the edges of the shutter.

It is also possible for the rotating member to incorporate one or more cylinders capable of rotating about their axes, which partially extend into a reservoir containing a liquid lubricant and which are mounted so as to bear on the side edges of the shutter 1. Instead of co-operating directly with a reservoir, the rotating element may be in contact with a wick impregnated with a liquid lubricant, for example.

FIG. 21 schematically illustrates another embodiment of the shutter device with a reservoir 52 containing liquid lubricant. The shutter 1 is wound onto a hollow drum 8, located above the bay 6, as illustrated in FIGS. 1 to 3. A reservoir 52 is provided inside each of the ends of the drum 8 on which the shutter 1 is wound.

This reservoir 52 is linked to the lubricating element via a conduit 53 extending along the longitudinal axis of the drum 8. Said conduit opens onto a metering device 54 mounted in the interior of the reservoir 52. This metering device looks like a spoon in appearance and rotates with the shaft 10 thereby permitting a quantity of liquid lubricant to flow intermittently towards the lubricating element as the drum 8 rotates. In particular, as the shutter 1 is opened or closed, the metering device 54 picks up a specific quantity of the liquid lubricant contained in the reservoir 52 with each rotation of the drum 8. This quantity of liquid lubricant flows via the conduit 53 towards the lubricating element.

This lubricating element may be provided in the form of a wick for example, which is in contact with the side edge of the shutter 1, or an orifice in the guide tracks through which the liquid is introduced into the latter in order to lubricate the contact surface between the side edges 2 and 3 of the shutter 1 and the guide tracks 4 and 5.

If the lubricating element has an orifice opening into the guide tracks 4 and 5 at a precise point, the liquid lubricant is distributed in the guide tracks 4 and 5 as the shutter 1 is displaced towards its closed position or its open position.

Using said metering device 54 enables the liquid lubricant contained in the reservoir 52 to be mixed if this liquid is made up of several components, for example.

FIG. 22 illustrates an embodiment of the reservoir 52 of the shutter device which differs from the preceding embodiment due to the fact that the conduit 53 extending along the longitudinal axis of the drum 8 is linked to the reservoir 52 by passages 55 extending through the shaft 10 transversely to this axis.

FIGS. 23 and 24 illustrate yet another embodiment of the shutter device proposed by the invention, in which a reservoir 39 for a liquid lubricant is provided at the bottom end of the bottom part 12 of the guide tracks 4 and 5.

The bottom end 40 of a wick 38 is immersed in the liquid lubricant contained in the reservoir 39. The top end 41 of this wick 38 is housed in a cutout 56 provided in the guide tracks 4 and 5 at a certain distance from the reservoir 39. This cutout 56 is specifically provided in the form of a cutout in the guide tracks 4 and 5 through which the top end 41 of the wick extends so as to enclose the corresponding side edge 2 or 3 of the shutter 1.

The part of the wick 38 extending between the reservoir 39 and the cutout 56 is retained in a cylindrical sleeve 27 which extends along the corresponding part of the guide tracks 4 and 5.

As the shutter 1 is moved to its open or closed position, liquid lubricant is applied to the bottom end of the side edges 2 and 3 of the shutter 1 via said wick 38. As the shutter 1 is subsequently moved towards the open position, this liquid lubricant is then distributed in the part of the guide tracks 4 and 5 located above the top end 41 of the wick 38. When the shutter 1 is then displaced towards its closed position, the side edges 2 and 3 of the shutter 1 are lubricated relative to the guide tracks 4 and 5.

Accordingly, the quantity of liquid lubricant present on the side edges 2 and 3 of the shutter 1 and in the guide tracks 4 and 5 is automatically metered. In particular, any surplus liquid lubricant on the side edges 2 and 3 or in the guide tracks 4 and 5 flows back down the guide tracks 4 and 5 into the reservoir 39.

The reservoir 39 is housed in a frame 58 with a U-shaped section, the flanges 59 and 60 of which extend on either side of the guide tracks 4 and 5. The edges of the flanges 59 and 60 are linked to one another by a plate 61, thus forming said reservoir 39 in the frame 59 between the flanges 59 and 60 and this plate 61.

The top of the reservoir 39 has a closure in the form of a plate 62 with two cutouts 63 and 64. Said wick extends through the first cutout 63, whilst the second cutout 64 allows the reservoir 39 to be topped up with liquid lubricant on the one hand and allows liquid lubricant in to flow back from the guide tracks 4 and 5 into the reservoir 39 on the other. To prevent any propagation of liquid lubricant to the side of the reservoir 39, said plate 61 extends slightly beyond the level of the plate 62.

As illustrated in FIG. 23, the reservoir 39 can be refilled using a syringe 65 by injecting liquid lubricant into the reservoir 39 through the cutout 64.

FIGS. 25 to 29 illustrate a scraper system allowing liquid lubricant present on the side edges 2 and 3 of the shutter 1 to flow back to the reservoir 39 illustrated in FIGS. 23 and 24.

This scraper system comprises a scraper element 66 provided in the top part 11 of the guide tracks 4 and 5 and enclosing the side edges 2 and 3 of the shutter and the part of the shutter 1 adjacent to these side edges 2 and 3.

As the shutter 1 is displaced towards its open position, the liquid lubricant present on the side edges 2 and 3 is removed by the scraper element 66 and flows via the guide tracks 4 and 5 to the reservoir 39.

The scraper element 66 has an inclined part 67, which extends between the base 26 of the frame 25 and the side edges 2 and 3 of the shutter 1, and a vertical part 68 extending along said base 26. The top end of the inclined part 67 extends through a cutout, specifically provided for this purpose in the flat pieces 31 and 32 on either side of the slit 34.

FIGS. 30 and 31 illustrate an embodiment of the shutter 1 proposed by the invention which has the advantage of enabling surplus liquid lubricant on the side edges 2 and 3 of the shutter 1 to flow back to said reservoir 39. In particular, the shutter 1 is provided with successive grooves 69 in the region adjacent to the side edges 2 and 3, which extend as far as these edges 2 and 3. The grooves 69 are parallel with one another and are inclined so that any liquid lubricant distributed on the shutter 1 in the region of these grooves 69 flows towards the side edges 2 and 3 located in the guide tracks 4 and 5. The liquid lubricant is than able to flow back along the side edges 2 and 3 or the guide tracks 4 and 5 to the reservoir 39.

In FIGS. 32 to 38 yet another embodiment of the lubricating element for the side edges 2 and 3 of the shutter 1 proposed by the invention is illustrated. The guide track 4 or 5 illustrated in these figures comprises a metallic section 70 in the form of U, in which is accommodated a sliding section 71, formed by two parallel cylinders 71′ and 71″ connected one to another as to present thus a section in the form of a 8.

In order to retain the sliding section 71 in the metallic section 70 the edges of the latter are folded one to another thereby enclosing the sliding section 71 in the area where the two cylinders of this section 71 are joining. Consequently, one of these cylinders 71″ extends outside the metallic section 70. The latter cylinder of the sliding section 71 is provided with a slit 72 extending along its longitudinal direction so that the side edge 2 or 3 of the shutter 1 can slide in this cylinder 71″ while the region of the shutter 1 adjacent to the side edge 2 or 3 extends through this slit 72.

Preferably, the sliding section 71 is made of a plastic material, such as for example polyethylene, whilst the side edges 2 and 3 of the shutter 1 are, for example, made of polyurethane.

The guide tracks 4 and 5 present a cutout 73 in which a lubricating element 74 is housed as illustrated in FIG. 32. In the embodiment of the invention illustrated in this figure, the cutout 73 is only provided in the part of the sliding section 71 extending outside the metallic section 70.

On both side edges of the upper part of the guide tracks 4 and 5 a flat piece 75, respectively 76 is mounted, which is provided with two supporting stops 77 and 78. The stops 77 an 78 of the respective flat pieces are directed one towards the other whilst keeping a free space between these respective stops, whereby the width of the free space substantially corresponds to the width of the slit 72.

When the side edge 2 or 3 is released from the bottom part of the corresponding guide track 4 or 5, the shutter 1 is moved towards its open position such that the side edge 2 or 3 of the shutter 1 is re-located in the concerned guide track 4 or 5 as a consequence of the contact between the side edge 2 and 3 and the lower stops 77.

The lubricating element 74, which is illustrated more in detail in the FIGS. 36 to 38, is fixed between the two flat pieces 75 and 76 and is located in the above-mentioned cutout 73.

FIG. 36 shows the lubricating element 74 which comprises a support 79 having a cylindrical form 80 with a slit 81 extending parallel to the axis of the cylinder 80 and over the whole length of thereof. Each of the edges of this slit 81 is delimited by surfaces 82 and 83 which extend parallel one to another and which are designed to enclose the region of the shutter 1 adjacent to the corresponding side edge 2 or 3 of the latter.

The edges of the surfaces 82 and 83 are folded towards the exterior and have a groove 84, respectively 85, in which the edge of the corresponding flat piece 75 or 78 is housed when the lubricating element 74 is mounted on the guide tracks 4 and 5 as shown in FIG. 35.

The inner diameter of the cylindrical part 80 of the support 79 substantially corresponds to the inner diameter of the cylinder 71″ of the sliding section 71 in which the side edge 2 or 3 of the shutter moves and the width of the slit 81 substantially corresponds to the width of the slit 72 of the sliding section. In this way, the support 79 encloses the side edge 2 and 3 of the shutter 1 when the lubricating element is mounted on the guide tracks 4 and 5.

The inner surface of the support 79 is preferably covered with a covering of an open-pored elastic material or a fibrous material impregnated with a liquid lubricant.

Such a covering 88, as illustrated in FIG. 37, is for example formed of a cloth having the form of a H which is applied against the inner surface 89 of the support 79. The arms 90 of this H are then folded back around the corresponding side edges of the aforementioned surfaces 82 and 83 in order to be fixed against the exterior side of the support 79. To this end, the support 79 has a groove 91 extending at the exterior side of the surfaces 82 and 83 close to the cylinder 80 and a groove 92 that is provided between the edges of the surfaces 82 and 83 and said grooves 84 and 85. The grooves 91 and 92 are directed towards each other. Accordingly, the abovementioned arms 90 can be housed in the grooves 91 and 92 against the exterior surface of the support 79.

The presence of the arms 90 permits to the increase the quantity of liquid lubricant that is contained in the covering 88.

The lubricating element 74 is for example manually impregnated with lubricating oil by means of a flask 93, as illustrated in FIG. 38.

It is clear that the lubricating element 74 does not necessarily have to be provided within a cutout in the guide tracks 4 or 5 and that this element 74 can be located at the upper end of the guide tracks 4 and 5 as well.

By means of the lubricating element 74 not only the side edges 2 and 3 of the shutter 1 are lubricated, this element 74 equally assures the cleaning of these side edges 2 and 3. In particular, when the shutter 1 is moved between its open position and its closed position, dust, such as for example grains of sand, which would be present on the sides edges 2 and 3, is collected on the lubricating element 74 and removed from the side edges 2 and 3. When this lubricating element 74 does not contain enough liquid lubricant anymore to lubricate the side edges 2 and 3 of the shutter 1 and/or when a certain quantity of dust is collected on the lubricating element 74, the latter is taken down from the guide tracks 4 and 5 and replaced by a new lubricating element 74.

The shutter device can also comprise a detection system allowing to detect whether the friction between the side edges 2 and 3 of the shutter 1 and the guide tracks is too high. When the friction is detected to pass a certain value, the shutter 1 is displaced towards its open position and the lubricating element 74 is replaced by a new lubricating element 74 which is impregnated with a liquid lubricant.

Such a detection system comprises, for example, a switch, which is provided in front of a cutout in the guide tracks 4 and 5. The dimensions of this cutout allow the side edges 2 and 3 of the shutter 1 to form a loop extending through this cutout thereby acting upon the aforementioned switch when the friction of the side edges 2 and 3 of the shutter 1 in the guide tracks 4 and 5 is exceeding a certain value when closing the shutter 1. The switch then cooperates with the command unit of the shutter device in order to move the shutter 1 into its open position and to give a signal that the lubricating element 74 has to be replaced.

Such a detection system is, for example, described in the patent application WO 02/066776.

It is clear that still other possibilities exist for detecting whether said friction between the side edges 2 and 3 of the shutter 1 and the guide tracks 4 and 5 exceeds a certain value. For example, it is possible to provide a detector in the region of the drum 8 onto which the shutter is wound, as equally described in the patent application WO 02/066776. When the shutter 1 is unrolled towards its closed position and said friction is too high such that the movement of the shutter is hindered, a loop is formed in the region close to the drum, whereby this loop is activating said detector so as to open the shutter 1 again. Then a signal is given that the side edges 2 and 3 of the shutter 1 have to be lubricated, for example, by replacing the lubricating element 74 or by a new impregnation of this element 74 with a liquid lubricant.

The invention is not limited to the various embodiments described above and other variants would be conceivable without departing from the scope of the present invention, particularly as regards the mounting of the reservoir relative to the guide tracks. For example, the reservoir containing the liquid lubricant could be mounted on the wall 7 and this reservoir linked to the lubricating element in the vicinity of the side edges of the shutter by means of an appropriate conduit.

If a reservoir with liquid lubricant is provided underneath the bottom end of the guide tracks, the side edges of the shutter may have a wick at their bottom end, which will be immersed in the liquid lubricant when the shutter is in the closed position. When the shutter is opened, this wick is displaced in the guide tracks, thereby applying the liquid lubricant in these guide tracks.

The description above relates to a liquid lubricant. However, under certain circumstances, it would also be possible to use a solid lubricating product in the form of one or more sticks, which are mounted so that one of their ends is brought to bear against the side edges of the shutter by means of a spring. A solid lubricant of this type might be paraffin, for example.

Furthermore, it goes without saying that the invention is not limited to a device whereby the shutter is wound on a drum. It would also be possible for the shutter to be folded into a box mounted above the opening as it is opened or for the shutter to be displaced in a horizontal plane above the opening.

The invention concerns in particular a shutter device of which at least one side edge is guided by a guide track in order to close off a bay or another opening. Thus, the shutter could, for example, be moved in a horizontal direction when it is hanged with a side edge in the guide track which is extending horizontally.

The shutter does not necessarily have to be moved vertically, but it can, for example, also be displaced horizontally to close off an opening extending in a horizontal plane.

Under certain circumstances, the side edges may have a bead made from an open-pored cellular elastomer to improve lubrication.

1. Shutter device designed to close off a bay (6) or other opening, the shutter (1) having at least one side edge (2, 3) being displaced in a guide track (4, 5) provided at one side of the bay or of the said other opening, characterised in that lubricating means (38, 39, 48, 49, 52, 74) are provided to enable the side edge (2, 3) of the shutter (1) to be lubricated.

2. Device as claimed in claim 1, characterised in that the lubricating means comprise a lubricating element (38, 48,74) disposed facing the side edge (2, 3) of the shutter (1), enabling this edge (2, 3) to be lubricated relative to the corresponding guide track (4, 5).

3. Device as claimed in claim 2, characterised in that the lubricating element (38, 48) co-operates with a reservoir (39, 49, 52) containing a liquid lubricant.

4. Device as claimed in claim 3, characterised in that the reservoir (39) extends along at least a part of the guide track (4, 5).

5. Device as claimed in claim 3, characterised in that the reservoir (39) is provided at the bottom end of the guide tracks (4, 5).

6. Device as claimed in any one of claims 3 to 5, characterised in that a scraper element (66) co-operates with the side edge (4, 5) of the shutter (1) causing any surplus liquid lubricant to flow back to the reservoir (39).

7. Device as claimed in any one of claims 3 to 6, characterised in that the lubricating element is a wick (38), one of the ends (40) of which extends into said reservoir.

8. Device as claimed in any one of claims 2 to 7, characterised in that the lubricating element is a wick (38) with a cutout (42) at one of its ends (41) in which the side edge (2, 3) of the shutter (1) is accommodated.

9. Device as claimed in claim 7 or 8, characterised in that the wick (38) is provided in the form of a strip of a porous material capable of absorbing the liquid lubricant, one part (40) of which extends in the direction of the guide track (4, 5), whilst the other part (41) extends substantially transversely to this direction and is in contact with the side edge (2, 3) of the shutter (1).

10. Device as claimed in any one of claims 3 to 9, characterised in that the lubricating element is a rotating member (48) mounted so as to bear against the side edge (2, 3) of the shutter (1) so that the member (48) is caused to rotate when the shutter (1) is opened or closed, this member (48) being able to co-operate with said reservoir (49) in order to distribute the liquid lubricant on the side edge (2, 3) of the shutter (1) as the member (48) rotates.

11. Device as claimed in claim 10, characterised in that the rotating member (48) is a bearing partially extending into the liquid lubricant of the reservoir (49).

12. Device as claimed in any one of claims 3 to 11, characterised in that the shutter (1) is wound on a drum (8) as the shutter is opened, this drum (8) being at least partially hollow in order to accommodate said reservoir (52).

13. Device as claimed in claim 12, characterised in that the drum (8) has a conduit (53) extending along the longitudinal axis of the drum (8) which links the reservoir (52) with the lubricating element (38, 48).

14. Device as claimed in claim 13, characterised in that said conduit (53) opens onto a metering device (54) extending into said reservoir (52) and enabling a quantity of liquid lubricant to flow towards the lubricating element (38, 48) when the drum (8) is rotated.

15. Device as claimed in any one of claims 2 to 14, characterised in that the lubricating element (38) at least partially encloses the side edge (2, 3) of the shutter (1).

16. Device as claimed in any one of claims 1 to 15, characterised in that grooves (69) are provided in the region adjacent to the side edge (2, 3) of the shutter (1) so that liquid lubricant flows towards this side edge (2, 3).

17. Device as claimed in claim 2, characterised in that the lubricating element (74) is, at least partially, made of an open-pored or fibrous material that is impregnated with a liquid lubricant.

18. Device as claimed in claim 17, characterised in that the lubricating element (74) is fitted in the guide track (4,5) or is mounted in the prolongation of the latter so that this element at least partially surrounds the corresponding side edge (2,3) of the shutter (1) when the latter is displaced in the guide track (4,5).

19. Device as claimed in claim 17 or 18, characterised in that the lubricating element (74) encloses the side edge (2,3) of the shutter (1) and the region of the latter adjacent to this side edge (2,3).

20. Device as claimed in any one of claims 17 to 19, characterised in that the lubricating element (74) is housed within a cutout (73) provided in the corresponding guide track (4,5).

21. Device as claimed in any one of claims 17 to 20, characterised in that the lubricating element (74) comprises a support (79) with an inner surface (89) which encloses the side edge (2,3) of the shutter (1), said inner surface (89) being covered with a covering (88) of said porous or fibrous material.

22. Device as claimed in claim 21, characterised in that a part of said covering (88) is folded back towards the outer surface of the lubricating element (74).

23. Lubricating element for a shutter device designed to close off a bay (6) or other opening, the shutter (1) having at least one side edge (2,3) being displaced in a guide track (4, 5) during the opening or the closure of the shutter (1), characterised in that the lubricating element (74) comprises a support (79) with an inner surface (89) which encloses the side edge (2,3) of the shutter (1), said inner surface (89) being covered with a covering (88) of an open-pored or fibrous material impregnated by a liquid lubricant.

24. Lubricating element as claimed in claim 23, characterised in that the inner surface (89) has a cylindrical form with a slit (81) extending parallel to the axis of this cylinder and along the whole length of the latter, each of the edges of this slit (81) having a surface (82, 83) extending parallel to each other and designed to enclose the region of the shutter (1) adjacent to the corresponding side edge (2, 3) of the latter.

25. Lubricating element as claimed in claim 23 or 24, characterised in that a part of said covering (88) is folded back towards the outer surface of said support.

26. Method for controlling the lubricating of at least one side edge (2,3) of a shutter (1) which is displaced between an open position and a closed position in order to open or close a bay (6) or another opening in a wall (7), the side edge (2, 3) of the shutter (1) being guided in a guide track (4, 5), characterised in that one detects whether the friction between the side edge (2, 3) and the guide track (4, 5) exceeds a certain value when the shutter (1) is displaced towards its closed position and that, when the friction is exceeding this value, the shutter (1) is displaced towards its open position and next a liquid lubricant is applied on the side edge (2, 3) of the shutter (1) when displacing it towards its closed position.

27. Method as claimed in claim 26, characterised in that said liquid lubricant is applied on the side edge (2, 3) of the shutter (1) by replacing the lubricating element (74), which is provided in the region of the displacement path of the side edge (2, 3) of the shutter (1) or by impregnating this lubricating element (74) with a liquid lubricant.

28. Method as claimed in claim 26 or 27, characterised in that, in order to detect whether said friction is exceeding said value, the forming of a loop in the side edge (2, 3) of the shutter (1) is detected when it is moved towards its closed position.

29. Method as claimed in claim 28, characterised in that a cutout is provided in the guide track (4, 5) through which said loop can extend when the friction is exceeding said value.

30. Method as claimed in claim 28, characterised in that a free space is provided upstream the guide track (4, 5) where said loop can be formed when the friction exceeds said value.

31. Method as claimed in any one of claims 28 to 30, characterised in that a detector is provided in the region where said loop can be formed.

32. Method as claimed in any one of claims 26 to 31, characterised in that the shutter (1) has a substantially incompressible zone extending according to the direction of the side edge (2, 3) of the shutter (1) such that a thrust force can be applied upon that zone according to said direction in order to move the shutter (1) towards its closed position.

33. Method as claimed in the preceding claim, characterised in that said incompressible zone comprises the side edge (2, 3) of the shutter (1).
